(19) United States
(12) Patent Application Publication
(10) Pub. No.: US 2022/0015378 A1
(43) Pub. Date: Jan. 20, 2022

(54) PRESERVATION PROCESS OF COOKED PIZZA

(71) Applicant: ALAI FOOD S.R.L., TODI (PERUGIA) (IT)

(72) Inventor: Fabrizio NINI, TODI (PERUGIA) (IT)

(21) Appl. No.: 17/298,074

(22) PCT Filed: Nov. 27, 2019
(86) PCT No.: PCT/EP2019/082702

§ 371 Date: May 28, 2021

(30) Foreign Application Priority Data
Nov. 29, 2018 (IT) 102018000010711

(51) Int. Cl. A21D 15/04; A21D 13/41; A21D 8/06; B65B 25/16; B65B 25/00

(52) U.S. Cl. CPC A21D 15/04; A21D 13/41; B65B 25/001; B65B 25/16; A21D 8/06

(57) ABSTRACT

A preservation process of cooked pizza is provided. The preservation process includes rolling cooked pizza and exactly inserting rolled pizza in a hermetic container that is successively exposed to a pasteurization process.

### CROSS-REFERENCE TO RELATED APPLICATIONS

This application is a National Phase Application of PCT International Application PCT/EP2019/082702, having an International Filing Date of Nov. 27, 2019 which claims priority to Italian Application No. 102018000010711 filed Nov. 29, 2018, each of which is hereby incorporated by reference in its entirety.

### TECHNICAL FIELD

The present patent application for industrial disclosure relates to a preservation process of cooked pizza.

### BACKGROUND

For many years, pizza has been considered a typical “homemade” food that is intended to be consumed“fresh” in order to enjoy its fragrant flavor at the ideal temperature.

With the passing of time, the growing popularity of this food has resulted in the industrial production of pizza to satisfy the“deferred” need of the users and, specifically, of those who intend to consume pizza at home.

Pizza is currently packaged after being cooked and sold to potential users, who simply need to heat the pizza before consumption.

According to the most common packaging techniques, cooked pizza is frozen and inserted in a packaging that can be stored at a low temperature; alternatively, cooked pizza can be packaged in plastic bags with modified atmosphere.

Evidently, the transportation of pre-cooked pizza from the production plant to the distribution place requires the use of suitable means of transportation to store the pizza at a low temperature. For this reason, the vehicles used for the transportation of similar pizza products must be provided with refrigeration systems to keep the pizza under a preset temperature value during transportation, with a high energy cost.

Moreover, similar pizza products must be displayed in refrigerated counters in the points of sales in order to be kept at the correct temperature, with a high energy cost.

Finally, it must be noted that, when the cooked pizza packaged according to either one of the aforementioned processes is consumed after being heated, the pizza is not very tasty and does not have the typical fragrance of fresh pizza.

US2005118305 discloses a process for making a pizza crust for use in making a Mexican style pizza as well as a process for making said Mexican style pizza.

US2002197360 discloses a kit for making or assembling a ready-to-eat deep dish pizza, wherein the pizza components are independently sealed in film pouches or bags using vacuum and then flushing with nitrogen before sealing.

CN102326600 discloses a process for pizza roll products.

### BRIEF SUMMARY

The purpose of the present disclosure is to disclose a new packaging method of cooked pizza that, after being heated before final consumption, is capable of maintaining a fragrance similar to the one of fresh pizza.

Such purpose is achieved by a process as described and claimed herein.

Advantageous embodiments of the disclosure are also described.

### BRIEF DESCRIPTION OF THE DRAWINGS

Additional features of the disclosure will appear manifest from the following detailed description that refers to a merely illustrative, not limiting embodiment, illustrated in the appended figures, wherein:

FIG. 1 is a diagrammatic view of a topped pizza before being rolled according to the process of the disclosure;

FIG. 2 is a view of the pizza of FIG. 1, after it is completely rolled;

FIG. 3 is a diagrammatic exploded view of the pizza roll of FIG. 2 immediately before being inserted in the container for packaging;

FIG. 4 is a view of the container with the pizza roll closed with the cap, sectioned with a vertical plane passing through the longitudinal axis of the container.

### DETAILED DESCRIPTION

With reference to the figures, the process of the disclosure is disclosed, which is suitable for guaranteeing a long-term preservation of the pizza.

In particular, the inventive idea that has permitted to achieve the specific purpose of the process according to the disclosure consists in the introduction of different modes for the preparation and packaging of pizza compared to the prior art, wherein the new preparation modes are preliminary to the new packaging modes.

The process of the disclosure provides for a first step that consists in the preparation of a dough obtained with traditional ingredients, mainly water and wheat flour.

The specific solution adopted in the process of the disclosure consists in the fact that the weight of the water used for the dough does not exceed 60% of the flour weight.

Then, the dough is laminated with a machine in order to obtain a pizza base (substantially a rectangular “sheet”) with a thickness of approximately 4 mm.

The pizza base is placed in a pan, after greasing the bottom; likewise the upper surface of the pizza base is greased to prevent undesired cracks and water leaks during rising.

Otherwise said, the purpose of the oil film applied on the surface of the pizza base is to maintain the integrity and the softness of the pizza base It must be noted that the thickness of the pizza base must remain constant during the execution of the two previous operations (placing the pizza base in the pan and greasing the upper surface of the pizza base).

When the pizza base has risen completely, the surface must be “perforated” and topped with the desired ingredients, transforming the pizza base into a raw finished pizza.

During the topping operation, all the ingredients must be positioned on the pizza base at the same time, in such a way to progressively transfer their humidity onto the surface of the pizza during the following cooking step.

During the cooking operation, the pizza is kept in a pre-heated oven, with open valve, for four minutes at a temperature of approximately 300° C., preferably 310° C., resting the pan with the pizza directly on the bottom of the oven.

Evidently, said first cooking step guarantees a considerable reduction of the bacterial charge of the pizza.

After the first cooking step, the pizza is extracted from the pan, is directly positioned on a grille suspended inside the oven, and remains in such a position for an additional cooking step for approximately three minutes.

As a matter of fact, this second cooking step—which is carried out while the pizza is positioned on the grille of the oven—practically eliminates the humidity created during the first cooking step, without impairing the crispness and all the other organoleptic characteristics that make the pizza similar to fresh pizza that has been recently come out of the oven.

When the pizza is completely cooked, the pizza is air-cooled without being placed in a packaging or on an especially cold surface; the purpose of the cooling step is that the pizza reaches the ambient temperature.

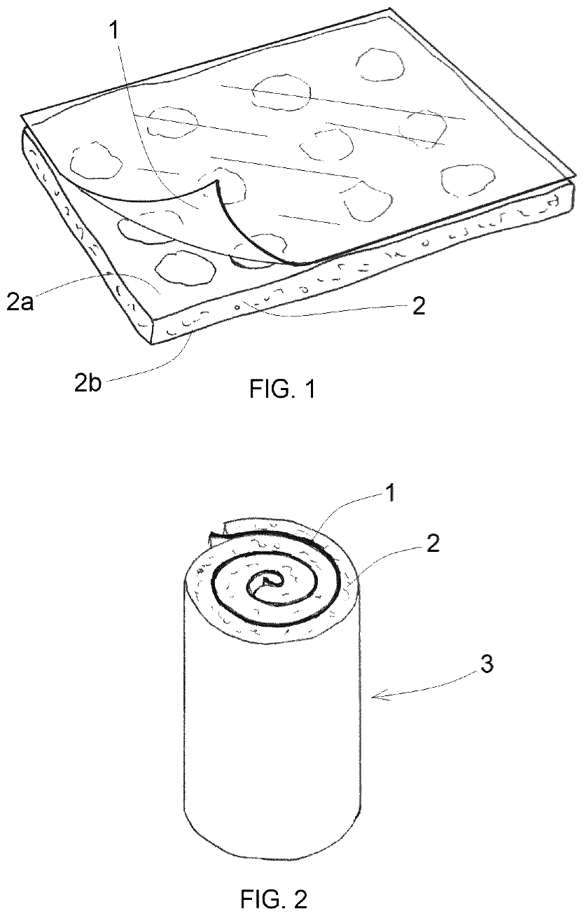

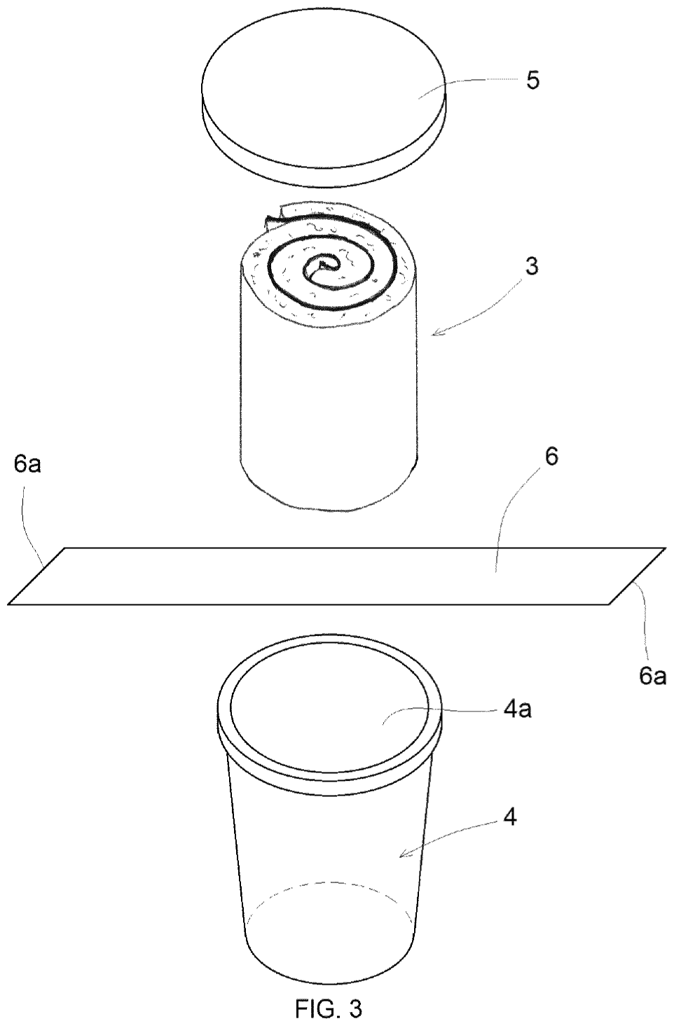

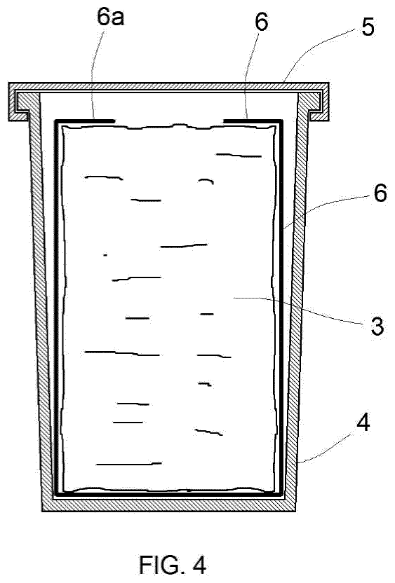

As shown in FIG. 1, a sheet of food-grade paper (1) is placed on the topped side (2a) of the pizza (2), which is now cooked, and the pizza (2) with said sheet of food-grade paper (1) is rolled until it becomes a roll (3) with cylindrical shape.

Such rolling operation is made by taking an edge of the pizza and folding said edge over the topped side (2a) of the pizza, until it is completely rolled, in such a way that the external surfaces of the roll coincides with the untopped side (2b) of the pizza.

In particular, the provision of said sheet of food-grade paper (1) on the topped side (2a) of the pizza prevents the toppings from sticking onto the untopped side (2b) of the pizza, when the pizza is rolled. Moreover, the application of such a food-grade paper partially maintains the humidity that is created on the topped side of the pizza during the first cooking step, so that the pizza can remain fragrant.

Because of such a configuration, the pizza can be exactly inserted in a cylindrical container (4) made of glass that can be filled completely (both along the width and the height) and closed with a hermetic cap (5).

Advantageously, before the pizza roll (3) is inserted in the container (4), a strip of paper (6) is positioned in the opening (4a) of the container, in such a way that said strip of paper (6) diametrically crosses said opening.

In view of the above, when the pizza roll (3) is inserted in the container (4), the strip of paper (6) is automatically pushed inside the container and disposed between the pizza roll (3) and the side of the container (4). The length of the strip of paper (6) is such that, after inserting the pizza roll (3) in the container (4), the ends (6a) of the strip of paper (6) protrude from the opening (4a) of the container, in such a way that said ends (6a) can be held and folded inwards, above the pizza roll (3) and under the hermetic cap (5) of the container.

The provision of such a strip of paper (6) helps the user to extract the pizza roll (3) from the container (4); as a matter of fact, after opening the container, the user can easily extract the pizza roll (3) by simply holding and lifting the ends (6a) of the strip of paper (6).

Moreover, because of the way the pizza is positioned in a container, the untopped side of the pizza remains visible through the glass walls of the container, whereas, when looking through the bottom of said container, and eventually through the hermetic cap, if the hermetic cap is made of glass—the user can see the turns of the pizza roll and the toppings disposed between said turns.

The following operation consists in immersing such a hermetically closed container in water in order to expose the pizza roll to a pasteurization process necessary to preserve the pizza roll for long.

In particular, said container is immersed in boiling water for approximately 15 minutes, and is brought back to ambient temperature quite rapidly.

It must be noted that pasteurization in boiling water can be replaced, with equivalent results, with the so-called flash pasteurization in retort.

In any case, at the end of the pasteurization process, the pizza can be finally marketed inside the glass container and stored for long at ambient temperature.

Because of the fact that the pizza of the disclosure can be kept at ambient temperature, all the aforementioned drawbacks of the frozen pizza that is currently available on the market can be remedied, avoiding the need to provide the transportation means and the store displays with refrigeration systems, thus dramatically reducing the energy cost associated with the transportation and the storage of the product.

Moreover, it must be noted that the aforementioned pasteurization process is carried out on cooked pizza, and not on“raw” pizza. By doing so, the pasteurization time can be reduced because the bacterial charge has already been eliminated from the previously cooked pizza.

After purchasing such a container, the user simply needs to extract the rolled pizza, flatten the pizza and heat the pizza in the oven, preferably at the temperature of 250° C.

In this way, the pizza can “revive”, reacquiring the physical and organoleptic characteristics that are normally found in a homemade pizza that has just come out of the oven.

Before finalizing this description, it is necessary to further clarify the reason of some operating decisions taken in the aforementioned process.

In particular, the importance of rolling the pizza in such a way to leave the topped side between the turns of the roll must be explained.

The cylindrical structure of such a rolled pizza is largely compatible with the structure of a typical glass container and, most of all, with the circular opening of the container.

Moreover, the section of the roll is such to permit the perfect insertion of the roll in the container in order to limit the stagnation of air between the external surface of the roll and the internal walls of the container.

Otherwise, the presence of an excessive amount of air inside the container would impair the technical result that is required by the pasteurization step. Moreover, the view of the pizza that is loosely contained inside the container would be unpleasant.

Furthermore, being comprised between the turns of the pizza roll, the toppings will stay on the pizza when the pizza is inserted through the opening of the container or when it is extracted from the container.

At the same time, the compactness of the rolled structure prevents the pizza from losing its integrity, getting damaged and being unpleasant to the consumer's eyes.

Although this description refers to a glass container closed with a hermetic cap, the rolled pizza can be also inserted in a metal can of the type that is generally used for peeled tomatoes.

Such a metal can is suitable for being exposed to the necessary pasteurization process in boiling water.

Finally, it must be noted that the applicant carefully analyzed the pizza obtained according to the process of the disclosure in order to assess its stability from the microbiological and chemical viewpoint.

In particular, the purpose of the analysis was to monitor the changes that may occur in certain preservation conditions in the quality of the pizza from the microbiological and chemical viewpoint and to establish the shelf life of the product.

Such an analysis was carried out in a set period of time of 120 days, in which pizza samples were stored at ambient temperature and analyzed at different time intervals of: 0-50-70-90-110 days.

The following parameters were examined: organoleptic characteristics (aspect), pH, acidity, water activity (aW), micro-organisms at 30° C., enterobacteriaceae, sulphite-reducing anaerobes, molds, lactic bacteria and yeasts.

Fourteen samples of pizza were taken for the analysis. One of the samples was analyzed immediately, whereas the other samples were stored at ambient temperature.

Following are the results of the test.

| | TIME (days) | | | | |
|---|---|---|---|---|---|
| | 0 | 50 | 70 | 90 | 110 |
| Aspect* | C | C | C | C | C |
| pH | 5.5 | 5.3 | 5.4 | 5.6 | 5.4 |
| Acidity | 0.2 | 19 | 0.56 | 0.39 | 0.5 |
| aW | 0.952 | 0.948 | 0.953 | 0.946 | 0.947 |
| CBT | 18000 | 3000000 | 2900000 | 26000 | 200000 |
| Sulphite-reducing anaerobes | <10 | <10 | <10 | <10 | <10 |
| Enterobacteriacee | <10 | <10 | <10 | <10 | <10 |
| Molds | <10 | <10 | <10 | <10 | <10 |
| Lactic bacteria | <10 | <10 | 51000 | 6800 | 1000 |
| Yeasts | <10 | <10 | <10 | <10 | 69000 |

*C: compliant (aspect and color of the product are normal)
NC: non-compliant

The analysis of the aforementioned results shows that:
the pH values are within the normal range, and are lower than the pH range with the highest development of bacteria, i.e. between 6.5 and 7.5;
the values of the bacteriological exams fall within the suggested limits of the scientific literature and of the regulations in force for these types of products; in particular, being a product intended for human consumption, the pathogenic micro-organisms must be absent and this condition is always complied with.

Therefore, based on the values of the pizza samples that were experimentally tested, the applicant calculated a stability time of the product of about 90 days.

1. A preservation process of cooked pizza, the preservation process comprising the following steps:
a) placing a raw pizza base on a previously greased bottom of a pan;
b) greasing an upper surface of said raw pizza base previously placed in said pan;
c) waiting for said raw pizza base to rise;
d) placing toppings on the upper surface of said raw pizza base, in order to obtain a topped pizza ready for cooking;
e) placing the pan with the topped pizza directly on a bottom of a pre-heated oven at a temperature of approximately 300° C., with open valve, leaving the topped pizza in the oven for four minutes;
f) extracting the topped pizza from the pan and placing the topped pizza directly on a suspended grille of the oven, leaving the topped pizza in the oven for additional three minutes;
g) extracting cooked pizza from the oven and cooling the cooked pizza naturally until it reaches an ambient temperature;
h) placing a sheet of food-grade paper on the topped side surface of the cooked pizza;
i) rolling the cooked pizza with the sheet of food-grade paper to obtain a pizza roll having cylindrical shape, wherein the toppings are contained between turns of said pizza roll;
l) inserting said pizza roll in a container having same shape and volume as the pizza roll;
m) closing the container hermetically; and
n) performing a pasteurization process on the closed container and its contents.

2. The preservation process of claim 1, wherein the pasteurization process comprises immersing said container and its contents in boiling water for approximately 15 minutes and cooling the container rapidly until the container reaches the ambient temperature.

3. The preservation process of claim 1, wherein the pasteurization process is a flash pasteurization process in retort.

4. The preservation process of claim 1, wherein the container suitable for housing the pizza roll is a glass jar having a hermetic cap.

5. The preservation process of claim 1, wherein the container suitable for housing the pizza roll is a hermetically re-sealable metal can of the type used for peeled tomatoes.

6. The preservation process of claim 1, wherein the raw pizza base suitable for being used in steps from a) to n) is obtained by the following steps:
α) preparing a pizza dough with traditional ingredients, mainly water and flour, providing that weight of water used for the pizza dough does not exceed 60% of flour weight; and
β) laminating said pizza dough to obtain said raw pizza base.

7. The preservation process of claim 6, wherein said raw pizza base has a thickness of 4 mm.

8. The preservation process of claim 6, wherein the flour used for said raw pizza base is wheat flour.

9. The preservation process of claim 1, wherein before the step of inserting the pizza roll in the container, a strip of paper is positioned in an opening of the container, in such a way that the strip of paper diametrically crosses said opening, so that, when the pizza roll is inserted in the container, the strip of paper is automatically pushed inside the container and disposed between the pizza roll and a side of the container; said strip of paper having a length that, after completely inserting the pizza roll in the container, ends of the strip of paper protrude from the opening of the container, in such a way that said ends are foldable inwards above the pizza roll and under the hermetic cap of the container.
